(19) United States
(12) Patent Application Publication
(10) Pub. No.: US 2013/0059631 A1
(43) Pub. Date: Mar. 7, 2013

(54) Agricultural harvesting machine

(71) Applicants: Frank CLAUSSEN, GREFFEN (DE); Thomas SURMANN, OELDE-STROMBERG (DE)

(72) Inventors: Frank CLAUSSEN, GREFFEN (DE); Thomas SURMANN, OELDE-STROMBERG (DE)

(21) Appl. No.: 13/587,261

(22) Filed: Aug. 16, 2012

(30) Foreign Application Priority Data
Sep. 2, 2011 (DE) 10 2011 053 214.5

(51) Int. Cl. A01D 75/18

(52) U.S. Cl. 460/2

(57) ABSTRACT

An agricultural harvesting machine includes at least one working assembly for processing and conveying crop as well as a sensor array (9) that detects hazardous substances (18) in the crop (10) to be processed.

### CROSS-REFERENCE TO A RELATED APPLICATION

The invention described and claimed hereinbelow is also described in German Patent Application DE 10 2011 053 214.5 filed on Sep. 2, 2011. This German Patent Application, subject matter of which is incorporated herein by reference, provides the basis for a claim of priority of invention under 35 U.S.C. 119(a)-(d).

### BACKGROUND OF THE INVENTION

The invention relates to an agricultural harvesting machine with a working assembly for processing and conveying crop and including a sensor array that detects hazardous substances in the crop to be processed.

Agricultural harvesting machines such as forage harvesters, combine harvesters or baling presses are known to travel across a field, in a self-propelled or drawn manner, during a harvesting operation to process and convey picked-up crop using one or more working assemblies. In order to achieve high utilization of machinery, harvesting is currently carried out during the day and at night. For that matter, on-going efforts are made to increase the productivity of the agricultural harvesting process as forward-travel speeds and working widths increase. Consequently, the operators of the machines must pay close attention in order to coordinate the complex working processes.

The field is not only a place to cultivate plants to be harvested, but also a living space for animals. During the harvesting operation, the machine operators of agricultural harvesting machines must therefore pay very close attention not only to coordinating the harvesting process but also to avoiding collisions with animals or even humans located in the field. Harvesting machines are known to pose a many times fatal hazard to living beings due to their working and conveyor assemblies, which have sharp edges and are driven powerfully. Furthermore, if a tragic collision with an animal occurs, the processing of the living being by the working and conveyance assemblies results in contamination of the crop that usually renders the crop unsuitable for use as feed. For example, dairy cattle perish of botulism if they ingest silage contaminated with animal cadavers. Even one deer that has been hit by a forage harvester can render an entire silo useless as feed since it is difficult to locate the contaminated portion of the crop in the silo.

In order to prevent collisions with animals present in a harvesting field, document DE 196 08 014 A1, for example, proposes that an infrared sensor be mounted on a bale wrapper in order to detect heat of living beings, which results in the bale winder being shut off. Document DE 102 44 822 A1 proposes that a sensor be mounted on a combine harvester in a danger zone, said sensor detecting living beings and halting the combine harvester as necessary.

Living beings cannot always be detected using the sensors of the above-described harvesting machines, however. One reason is that the detection region of sensors is always limited. Another reason is that animals in the plant crop are often difficult to detect because they hide or suddenly run into the path of the harvesting machine. Furthermore, changing operating conditions impair the reliability of the sensors. Practical experience has shown that, despite on-going efforts, it cannot be ruled out that living beings will be hit by harvesting machines. One result thereof is, inter alia, economic loss due to the loss of value of the crop.

In addition, cases of sabotage are often carried out before the harvest, in which third parties hide chemicals (household cleaning products, for example) at or in the plant crop. The chemicals can thereby enter the crop unnoticed. The chemicals pose a hazard, in particular, with respect to the subsequent use of the harvested material in biogas plants since they easily influence the sensitive bacteria in the substance circulation of the plant, thereby disrupting the production of biogas.

### SUMMARY OF THE INVENTION

The present invention overcomes the shortcomings of known arts, such as those mentioned above.

To that end, the invention provides a harvesting machine such as those described above but that is configured to limit economic losses caused by unwanted events that occur during harvesting, such as collisions with living beings or sabotage carried out on the plant crop.

For example, the invention provides an agricultural harvesting machine with a working assembly for processing and conveying crop, wherein a sensor array is included to detect hazardous substances in the crop to be processed and/or in the processed crop.

According to the invention, it was first recognized that it has not been possible to fully rule out collisions with living beings during a harvesting operation using technical means having a justifiable level of complexity. In order to at least rule out further endangerment of living beings downstream in the food chain, more particularly animals that are fed crop, and/or endangerment of downstream technical processes, the harvesting machine according to the invention comprises a sensor array that detects the hazardous substances in the processed crop.

Basically any substance can be considered a hazardous substance that poses a hazard in a broader sense to the harvested product and in the subsequent use thereof. This is the case, for example, when the crop is rendered unsuitable for use as animal feed by the hazardous substance contained therein or when the hazardous substance disrupts the production of biogas. By detecting such hazardous substances, the sensor array provided according to the invention helps to prevent or at least diminish economic losses incurred in such a manner by making it possible for the machine operator to remove the crop that was recognized as being contaminated from the downstream production chain. Advantageously, the hazardous substances are therefore substances that can be detected using the sensor array.

As previously described, a hazardous substance in the above-noted sense can be a substance that renders the crop unsuitable for use as animal feed. This includes, for example, animal substances, that is, any substances originating from an animal organism (including human, therefore, in the natural-scientific sense). These animal originating substances may include, without limitation, flesh, blood and/or bones thereof. In addition, fungal infestation of the crop can render the crop unsuitable for subsequent use. For example, mycotoxins are known to be a metabolic product of mold that have toxic effects on vertebrates even in small doses and must, therefore, be considered hazardous substances.

Furthermore, chemical substances that have any type of value-diminishing effect on the use of the crop also can be considered hazardous substances in the sense of the invention particularly including a case where the chemical substance impairs the production of biogas.

In principle, various types of sensors can be used to detect hazardous substances. According to an advantageous embodiment of the invention, the sensor array comprises an optical sensor that optically detects the processed crop in order to derive information therefrom regarding the presence of a hazardous substance. Optical detection offers the advantage of enabling the crop to be examined in a contactless manner. Placement of the sensor array (at least the optically detecting elements thereof) at the crop flow advantageously makes it possible to perform a continuous measurement, thereby permitting rapid detection of the presence of hazardous substances and/or changes related thereto. Furthermore, the sensor array advantageously comprises an evaluation unit that derives information from the sensor signal generated regarding the presence of hazardous substances.

Advantageously, hazardous substances are detected using a sensor array that spectroscopically analyzes the crop in the near infrared range (NIR). To this end, the crop is exposed to short-wavelength infrared radiation in a highly targeted manner, for example, by way of a related light source. Certain molecular bonds of the irradiated material are excited to oscillate in response to the exposure. The reflected radiation is analyzed using a suitable detection device and an evaluation unit connected thereto. More particularly, by way of comparison with known data, the evaluation unit detects certain hazardous substances, such as animal blood or known chemical substances that are contained in the crop.

Initially, the evaluation is limited to determining that the derived information contains the presence of a hazardous substance per se. This purely qualitative information alone can suffice to avert pending harm as quickly as possible.

Advantageously, the information also contains the type of hazardous substance that was detected. In this manner, the machine operator is notified, for example, that the crop contains a certain chemical substance or a certain type of animal blood. Based on the type of hazardous substance, the machine operator can determine what event took place (sabotage, collision with an animal, fungal infestation, etc.) and initiate suitable action.

Preferably, the derived information also contains the quantity of the hazardous substance in the crop. The information can be relative (in the sense of a concentration, such as the portion by weight or volume of the currently detected crop) or absolute. An absolute quantity is determined, for example, by integrating the relative quantity over a known crop throughput. Quantity information supports machine operators in their assessment of the danger posed by the contamination.

The sensor array used for hazard detection is preferably a sensor array capable of detecting properties (for example, moisture, protein content, raw fiber content, etc.) of the crop itself. A dual use of this type greatly reduces the design complexity.

Furthermore, an output unit is assigned to the sensor array. The output unit is operated to output information to a machine operator related to the presence of the hazardous substance that was detected. The output can take many forms including the form of pure information, for example, by way of a display in the driver's cab that is visible to the machine operator. In order to provide the information with the character of an important message, the information may be output acoustically and/or appear as a warning message that is emphasized visually in a special way (in a signal color and in an appropriate size).

Preferably, the output device outputs a signal to the machine operator if a critical quantity of a detected hazardous substance is exceeded. In this case, the machine operator is warned by way of a signal only when a critical quantity of the hazardous material is exceeded. As such, the (absolute or relative) quantity to be reached therefor preferably is set by the operator.

Alternatively, a machine-related action is triggered if a critical quantity of a detected hazardous substance is exceeded. Different actions that are preferably dependent on the type and/or quantity of hazardous substance that was detected are feasible in this case. For example, an immediate stoppage of assemblies (for example, in the case of a forage harvester or combine harvester: intake assembly, front attachment, ground drive) of the harvesting machine could be triggered in order to interrupt the conveyance of crop or the cutting height could be changed to stop drawing in hazardous substances located on the ground.

Also, a targeted addition of chemical substances and/or ensiling agent to the crop is automatically initiated in response to the detection of a hazardous substance in order to reduce or entirely compensate the negative effect of the hazardous substance. The initiation of such actions can be integrated into an on-board machine monitoring system of the harvesting machine and could therefore be triggered automatically.

One embodiment the harvesting machine also provides a device that can be operated to document information related to the presence of hazardous substances according to location. Such device accesses a satellite-supported (or other type of) position-finding system in order to assign the information accordingly. In a practical application, the device enables indication of the exact point of discovery of collision with an animal in this manner, for example, in order to notify a responsible land manager, forester or hunter about the loss in the animal population or about the discovery.

### BRIEF DESCRIPTION OF THE DRAWINGS

Further features and advantages of the invention will become apparent from the description of embodiments that follows, with reference to the attached figures, wherein:

FIG. 1 depicts a schematic side view of a self-propelled forage harvester before collision with a deer; and

FIG. 2 depicts a schematic side view of the self-propelled forage harvester according to FIG. 1 before it picks up a chemical substance.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

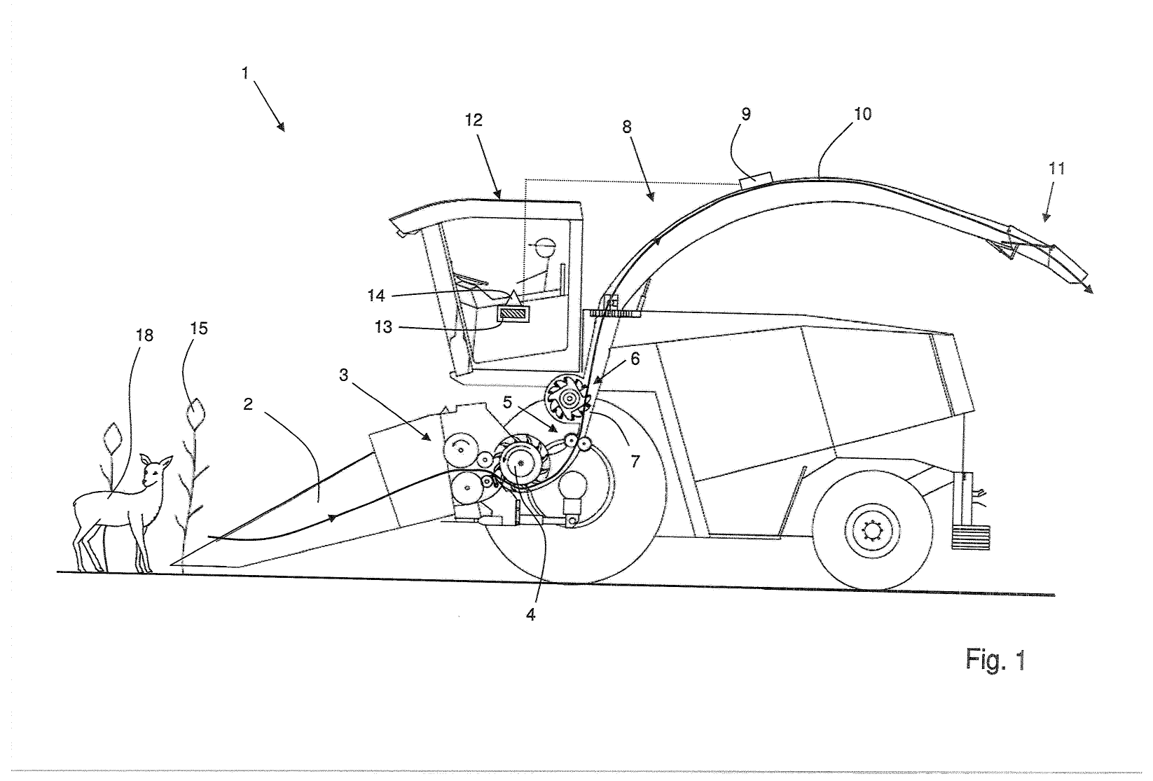

FIG. 1 shows an agricultural harvesting machine in the form of a self-propelled forage harvester 1 one embodiment of the invention. In order to harvest plant crop 15 growing on the field, the forage harvester 1 comprises a front attachment 2, which cuts the plants and feeds them in the form of a stream of material to an intake assembly 3 equipped with rotating compression rollers. After being compressed there, the crop 10 enters a chopping assembly 4, where fragmentation to a desired length of cut takes place via interaction of a chopper drum equipped with knives opposite a stationary shear bar (neither of which is shown). The chopping assembly 4 is followed by (in the direction of the material flow indicated by the arrow direction of the crop 10 through the machine), a conditioning device 5 and a post-accelerator 6, which are disposed in a conveyor chute 7 rising behind a driver's cab 12. The conveyor chute 7 leads into an upper discharge chute 8, which is used to transfer the crop 10 (passing through the processing and conveying assemblies 3, 4, 5) to a loading container (not shown). A discharge flap 11 disposed at the end of the upper discharge chute 8 facing away from the machine makes it possible to control the direction in which the stream of crop emerging from the upper discharge chute 8 is discharged. An operator sits in the driver's cab 12 in order to steer and generally control the self-propelled forage harvester 1.

As indicated in FIG. 1, animals occasionally stand around in the plant crop 15, such as a deer 18 as shown. Despite careful vigilance, collisions with the animals sometimes occur, tragically. Such collisions can even occur unnoticed depending on the particular harvesting circumstances (darkness, tall plant crop, loud noise level). If such an event does occur, animal substances enter the crop 10 by way of the processing and conveying assemblies of the forage harvester 1. If the crop 10 is subsequently stored in a silo for eventual use as animal feed, the admixture of the animal substances renders the silage unusable. For example, dairy cattle become ill or perish from botulism. After the harvest it is extremely difficult or impossible to locate contaminated regions in the silage. As a result, such accidents with wild game can result, inter alia, in considerable economic loss.

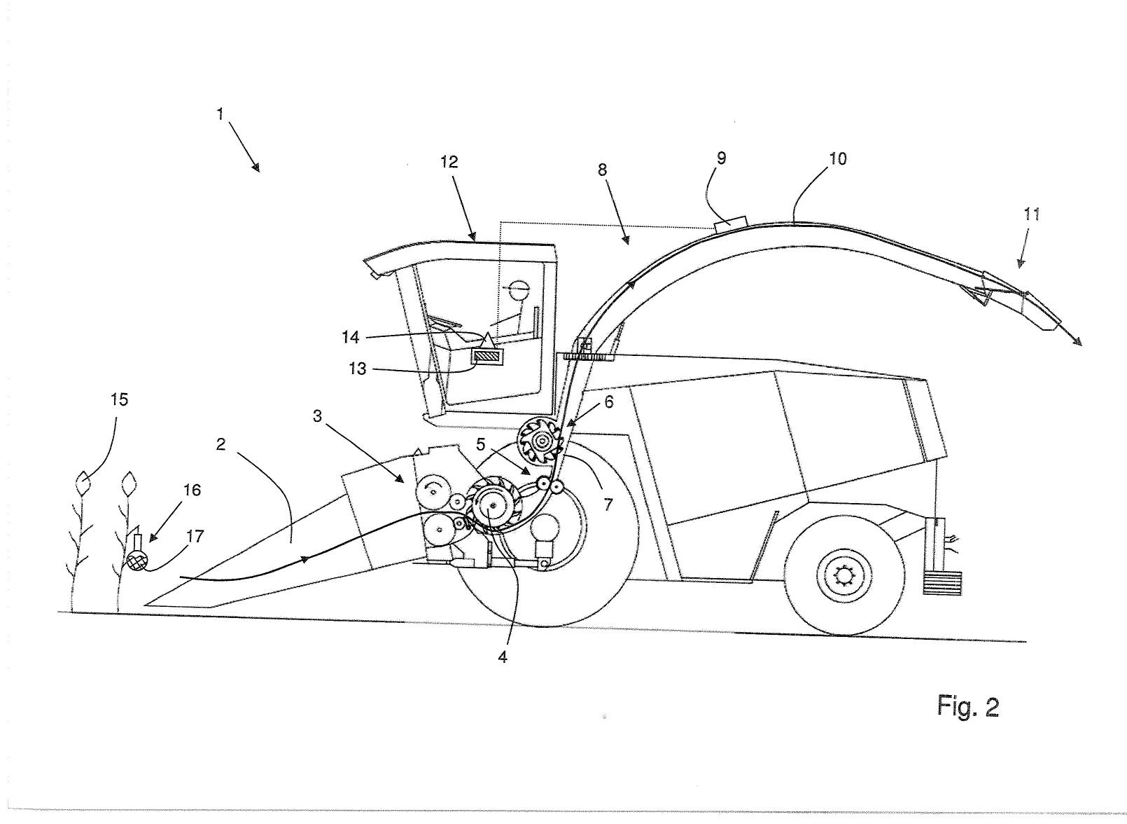

As shown in FIG. 2, it also occurs that containers 16 and/or other objects, which contain a chemical substance 17, are hidden in the plant crop 15 by third parties for purposes of sabotage. For example, chemical substance 17 is designed such that after having been conveyed and processed in the forage harvester 1, it affects the discharged crop 10 in such a way that intended biogas production using the crop 10 is considerably impaired. This occurs, for example, when the chemical substance 17 is a household cleaning product. The economic loss caused in this manner can be considerable when large quantities of crop 10 become unnoticeably contaminated.

In order to minimize the damage in the cases described, the forage harvester 1 according to the invention (as shown in FIGS. 1 and 2), comprises a sensor array 9 that detects hazardous substances contained in the processed crop 10. In FIG. 1, the hazardous substance is an animal substance (e.g. blood, flesh, bone) of an animal that has been hit; in FIG. 2, the hazardous substance is a chemical substance 17.

In order to detect the particular hazardous substance, the crop 10 flowing through the upper discharge chute 8 is optically detected in the rear region of the upper discharge chute 8, that is, at the curved outer wall along which the processed crop 10 glides. To this end, the sensor array 9 comprises a (not shown) illumination source for irradiating the crop 10 with short-wavelength infrared light and an optical system for directing and bundling the light. A detector (not shown) assigned to the sensor array 9 detects the radiation spectrum reflected by the crop 10. An analysis of the spectrum carried out by the sensor array 9 is used to deduce information regarding the possible presence of a hazardous substance in the crop 10. This takes place, for example, in an evaluation unit by comparing the radiation spectrum that is received with stored values.

As depicted in FIG. 2, the container 16 (or any other type of object) containing the chemical substance 17 is about to be hit and destroyed by the traveling forage harvester 1. As travel continues and processing is carried out in the forage harvester 1, the chemical substance 17 spills in the crop 10 and mixes therewith. The sensor array 9 based on NIR technology that is provided continually monitors the crop 10 conveyed past it and detects the chemical substance 17 contained in the crop 10 as a hazardous substance.

As indicated by the dotted line, the sensor array 9 transmits a signal to the output device 13 connected thereto, thereby ensuring that the machine operator is informed about the presence of a hazardous substance 17. The output can take place visually, for example, via a display and, in addition, in an acoustically audible manner. This ensures that the machine operator is notified as quickly as possible about the danger even while he carefully tracks other processes. Advantageously, the operator also is informed about the type of hazardous substance and, possibly, about the relative quantity thereof in the crop 10.

Advantageously, the information is documented according to location using a device 14. To this end, the device 14 is equipped with a satellite-supported receiver and a memory device, thereby making it possible to locate and store the particular location where the hazardous substance 17 was found.

Alternatively or in addition to the chemical substance 17, other hazardous substances also can be detected using the sensor array 9. As shown in FIG. 1 it also is possible to detect animal substances (animal blood, etc.) in the crop 10 that have entered the conveying and processing assemblies 3, 4, 5 of the forage harvester 1 due to a collision with an animal 18 or in any other manner. Within the scope of chopping grass, for instance, it is possible that animals will be killed even during preparatory mowing of the grass and this will remain unnoticed in subsequent working processes such as turning and swathing. Hence, animal substances can enter the crop in this manner, besides by way of a collision with a living animal, namely in that the animal that has already been killed lies hidden in the grass swath during the actual chopping process.

In deviation from the forage harvester 1 that is shown, it should be noted that harvesting machines such as combine harvesters, baling presses or other harvesting machines that process and convey a stream of crop can be equipped with a sensor array for detecting hazardous substances in the crop while achieving the effects and advantages according to the invention.

The following list of reference signs of various elements mentioned above is included (as follows), for ease of explanation:

### List of reference characters

1 forage harvester
2 front attachment
3 intake assembly
4 chopping assembly
5 conditioning device
6 post-accelerator
7 conveyor chute
8 upper discharge chute
9 sensor array
10 crop
11 discharge flap
12 driver's cab
13 display unit
14 data processing unit
15 plant crop
16 container
17 chemical substance
18 deer

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An agricultural harvesting machine (1) comprising
at least one working assembly (3, 4, 5) for processing and conveying crop (10); and
a sensor array (9) that detects a hazardous substance (17, 18) in the crop (10) to be processed.

2. The harvesting machine according to claim 1, wherein the hazardous substance is a substance (18) that renders the crop (10) unsuitable in terms of animal feed.

3. The harvesting machine according to claim 1, wherein the hazardous substance is an animal substance (18).

4. The harvesting machine according to claim 1, wherein the hazardous substance is a chemical substance (17).

5. The harvesting machine according to claim 1, wherein the sensor array (9) comprises an optical sensor that optically detects the processed crop (10) in order to derive information therefrom regarding the presence of a hazardous substance (17, 18).

6. The harvesting machine according to claim 5, wherein the sensor array (9) operates to analyze the crop (10) spectroscopically in the near infrared range.

7. The harvesting machine according to claim 5, wherein the information contains an indication of the presence of a hazardous substance (17, 18).

8. The harvesting machine according to claim 5, wherein the information contains the type of hazardous substance (17, 18).

9. The harvesting machine according to claim 5, wherein the information contains a quantity of the hazardous substance (17, 18) in the crop (10).

10. The harvesting machine according to claim 1, wherein the sensor array (9) detects the hazardous substance (17, 18) and properties of the crop (10).

11. The harvesting machine according to claim 1, wherein an output device (13) is assigned to the sensor array (9) that is operated to output information to a machine operator related to the presence of the hazardous substance (17, 18) if detected.

12. The harvesting machine according to claim 11, wherein the output device (13) outputs a signal to the machine operator if a critical quantity of a detected hazardous substance (17, 18) is exceeded.

13. The harvesting machine according to claim 1, wherein a machine-related action is triggered if a critical quantity of a detected hazardous substance (17, 18) is exceeded.

14. The harvesting machine according to claim 1, wherein a device (14) is provided that operates to document information related to the presence of hazardous substances (17, 18) according to location.
